(19) United States
(12) Patent Application Publication
(10) Pub. No.: US 2004/0031237 A1
(43) Pub. Date: Feb. 19, 2004

(54) Packaging having a scent indicative of a characteristic of the package or item contained within the package

(76) Inventor: Donald E. Weder, Highland, IL (US)

Correspondence Address: DUNLAP, CODDING & ROGERS P.C., PO BOX 16370, OKLAHOMA CITY, OK, 73113, US

(21) Appl. No.: 10/636,378

(22) Filed: Aug. 6, 2003

Related U.S. Application Data
(63) Continuation of application No. 10/014,753, filed on Dec. 12, 2001, now abandoned.
(63) Continuation-in-part of application No. 10/390,371, filed on Mar. 17, 2003.
Application No. 10/390,371 is a continuation of application No. 10/005,005, filed on Dec. 4, 2001, now abandoned.
Application No. 10/005,005 is a continuation of application No. 09/746,384, filed on Dec. 21, 2000, now Pat. No. 6,370,840.
Application No. 09/746,384 is a continuation of application No. 09/491,003, filed on Jan. 25, 2000, now Pat. No. 6,178,727.
Application No. 09/491,003 is a division of application No. 09/035,473, filed on Mar. 5, 1998, now Pat. No. 6,112,500.
Application No. 09/035,473 is a continuation of application No. 08/796,099, filed on Feb. 5, 1997, now Pat. No. 5,740,656.
Application No. 08/796,099 is a continuation of application No. 08/462,342, filed on Jun. 5, 1995, now Pat. No. 5,636,502.
Application No. 08/462,342 is a continuation of application No. 08/252,876, filed on Jun. 2, 1994, now Pat. No. 5,609,009.

(51) Int. Cl. A01G 9/02; B65B 13/00

(52) U.S. Cl. 53/397; 47/72

(57) ABSTRACT

A method of forming a scented decorative cover, a scented sleeve or a scented preformed pot cover for a floral grouping or flower pot from a sheet of material having a printed pattern and a scent corresponding to the printed pattern thereon.

### CROSS REFERENCE TO RELATED APPLICATIONS

This application is a continuation of U.S. Ser. No. 10/014,753, filed Dec. 12, 2001. This application is also a continuation-in-part of U.S. Ser. No. 10/390,371, filed Mar. 17, 2003; which is a continuation of U.S. Ser. No. 10/005,005, filed Dec. 4, 2001, now abandoned; which is a continuation of U.S. Ser. No. 09/746,384, filed Dec. 21, 2000, now U.S. Pat. No. 6,370,840, issued Apr. 16, 2002; which is a continuation of U.S. Ser. No. 09/491,003, filed Jan. 25, 2000, now U.S. Pat. No. 6,178,727, issued Jan. 30, 2001, which is a divisional of U.S. Ser. No. 09/035,473, filed Mar. 5, 1998, now U.S. Pat. No. 6,112,500, issued Sep. 5, 2000; which is a continuation of U.S. Ser. No. 08/796,099, filed Feb. 5, 1997, now U.S. Pat. No. 5,740,656, issued Apr. 21, 1998; which is a continuation of U.S. Ser. No. 08/462,342, filed Jun. 5, 1995, now U.S. Pat. No. 5,636,502, issued Jun. 10, 1997; which is a continuation of U.S. Ser. No. 08/252, 876, filed Jun. 2, 1994, now U.S. Pat. No. 5,609,009, issued Mar. 11, 1997.

### STATEMENT REGARDING FEDERALLY SPONSORED RESEARCH

Not applicable

### BACKGROUND OF THE INVENTION

The present invention relates to methods for providing decorative covers for floral items and more particularly, but not by way of limitation, to methods for providing decorative covers for floral items with a material having a scent indicative of a color or a floral item to be disposed therein.

### BRIEF SUMMARY OF THE INVENTION

The present invention relates to methods of wrapping floral groupings, flower pots and other floral items with a sheet of material to form a scented decorative package about the floral grouping, flower pot or floral item. The sheet of material is provided with a scent on at least a portion of at least one surface of the sheet of material and includes a printed pattern on at least a portion of one surface of the sheet of material. The scent and printed pattern are coordinated such that the printed pattern is indicative of the scent on the sheet of material. The printed pattern and the scent on the sheet of material can also be coordinated so that both are indicative of a floral item and/or color of a floral item contained in the scented decorative package formed from the sheet of material. The printed pattern on the sheet of material to which the scent corresponds can be printed matter such as graphics, words, images, solid colors, or designs disposed on the sheet of material.

According to the present invention, methods are provided for packaging floral items with a packaging material having a scent indicative of a color or of an item(s) packaged therein.

### BRIEF DESCRIPTION OF THE DRAWINGS

FIG. 1 is an enlarged, fragmental, perspective view of a sheet of material constructed in accordance with the present invention wherein the sheet of material has a scent indicative of a floral item and/or color of a floral item.

FIG. 2 is a perspective view of the sheet of material of FIG. 1 having a bonding material disposed along one edge thereof, one corner of the sheet of material being upwardly turned to illustrate a lower side thereof.

FIG. 3 is a perspective view of the sheet of material of FIG. 2 having a floral grouping disposed thereon.

FIG. 4 is a perspective view of the floral grouping being wrapped with the sheet of material of FIG. 3.

FIG. 5 is a perspective view of a decorative cover for the floral grouping formed from the sheet of material of FIG. 3.

FIG. 6 is a perspective view of a decorative cover formed from the sheet of material of FIG. 3 wherein the floral grouping is wrapped with the sheet of material by a second method of wrapping so that the decorative cover formed from the sheet of material has a substantially cylindrical configuration.

FIG. 7 is a perspective view of a flower pot containing a potted plant.

FIG. 8 is a perspective view of a sheet of material having a bonding material disposed on substantially one surface thereof one corner of the sheet of material being upwardly turned to illustrate a lower side thereof.

FIG. 8A is perspective view of a decorative cover positioned about the flower pot of FIG. 7.

FIG. 9 is a cross-sectional view of a flower pot cover former and band applicator apparatus having a sheet of material disposed above an opening of the flower pot cover former and band applicator and having a flower pot disposed above the sheet of material.

FIG. 10 is a perspective view of a floral sleeve having a scent indicative of a floral item and/or color of a floral item constructed in accordance with the present invention.

FIG. 11 is a perspective view of the floral sleeve of FIG. 10 disposed about a floral grouping.

FIG. 12 is a perspective view of a floral sleeve having a cinching member wherein the floral sleeve is provided with a scent indicative of a floral item and/or color of a floral item.

FIG. 13 is a perspective view of the floral sleeve of FIG. 12 disposed about a floral grouping.

FIG. 14 is an elevational view of a sleeve having a detachable portion wherein the sleeve is provided with a scent indicative of a floral item and/or color of a floral item.

FIG. 15 is a perspective view of the sleeve of FIG. 14 having a flower pot disposed therein.

FIG. 16 is a perspective view of the sleeve of FIG. 15 having the flower pot disposed therein wherein an upper portion of the sleeve has been removed to provide a decorative cover having a skirt.

FIG. 17 is a perspective view of a preformed pot cover.

FIG. 18 is a perspective view of the preformed pot cover of FIG. 17 having a flower pot disposed therein.

FIG. 19 is a diagrammatic, cross-sectional view of a male and female mold having a sheet of material disposed there between for forming the preformed pot cover of FIG. 17.

### DETAILED DESCRIPTION OF THE INVENTION

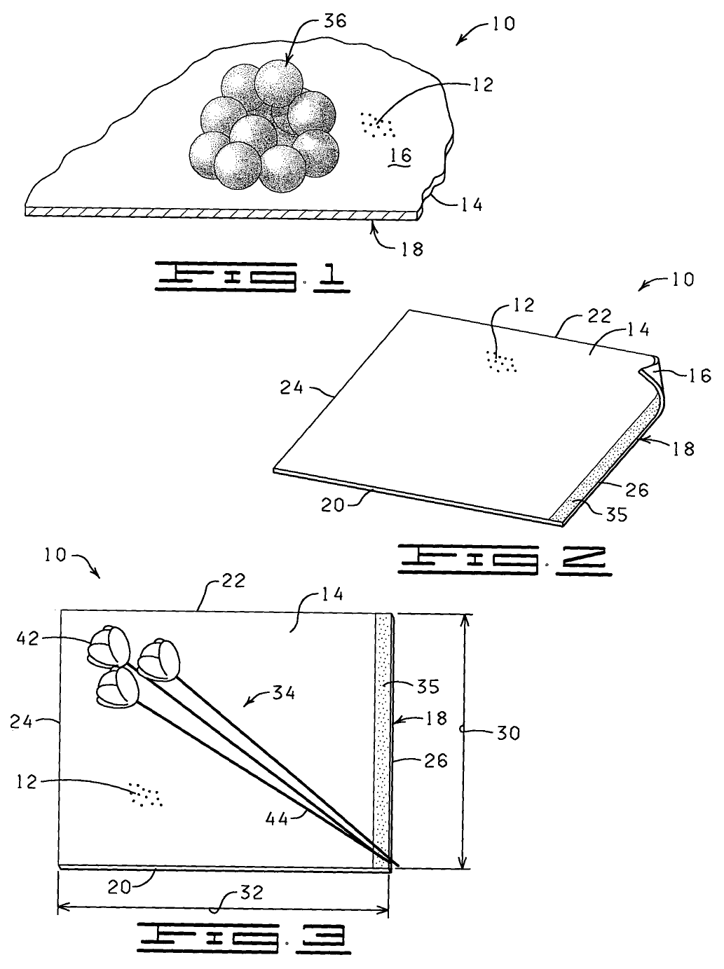

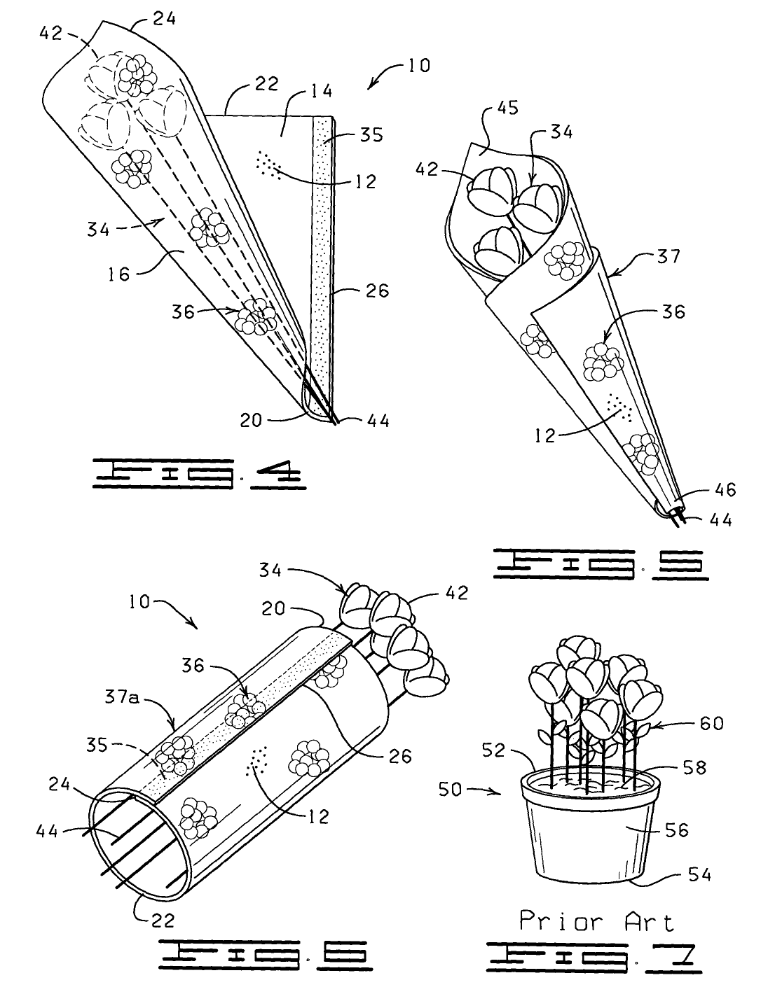

Referring now to the drawings, and more particularly to FIGS. 1-3 shown therein is a sheet of material 10 having a scent 12 thereon. The sheet of material 10 is characterized as having an upper surface 14, a lower surface 16, and an outer peripheral edge 18. As shown in FIGS. 2 and 3, the outer peripheral edge 18 of the sheet of material 10 is provided with a first side 20, a second side 22, a third side 24, and a fourth side 26. As shown in FIG. 3, the sheet of material 10 has a width 30 extending generally between the first side 20 and the second side 22 of the outer peripheral edge 18 or the sheet of material 10; and a length 32 extending generally between the third side 24 and the fourth side 26 of the outer peripheral edge 18 of the sheet of material 10. The sheet of material 10 is sufficiently sized so that the sheet of material 10 extends over a substantial portion of a floral grouping 34 (FIG. 3) when the sheet of material 10 has been wrapped about the floral grouping 34 in accordance with the present invention, as described in detail herein.

“Floral grouping” or “floral item” as used herein means cut fresh flowers, artificial flowers, a single flower or other fresh and/or artificial plants or other floral materials and may include other secondary plants and/or ornamentation or artificial or natural materials which add to the aesthetics of the overall floral grouping. Further, the “floral grouping” or “floral item” may be a growing potted plant having a root portion as well. However, it will be appreciated that the floral grouping or floral item may consist of only a single bloom or only foliage, or a botanical item (not shown), or a propagule. The term “floral grouping” or “floral item” may be used interchangeably herein with the term “floral arrangement”. The term “floral grouping” or “floral item” may also be used interchangeably herein with the terms “botanical item” and/or “propagule.”

The term “growing medium,” when used herein, means any liquid, solid or gaseous material used for plant growth or for the cultivation of propagules, including organic and inorganic materials such as soil, humus, perlite, vermiculite, sand, water, and including the nutrients, fertilizers or hormones or combinations thereof required by the plants or propagules for growth.

The term “botanical item” when used herein means a natural or artificial herbaceous or woody plant, taken singularly or in combination. The term “botanical item” also means any portion or portions of natural or artificial herbaceous or woody plants including stems, leaves, flowers, blossoms, buds, blooms, cones, or roots, taken singularly or in combination, or in groupings of such portions such as bouquet or floral grouping.

The term “propagule” when used herein means any structure capable of being propagated or acting as an agent of reproduction including seeds, shoots, stems, runners, tubers, plants, leaves, roots or spores.

A bonding material 35 (FIGS. 2, 3 and 4) may be disposed on at least a portion of one or both of the upper and/or lower surfaces 14 and 16 of the sheet of material 10, such as the upper surface 14 thereof as shown in FIGS. 2-4 and as further illustrated in U.S. Pat. No. 5,181,364 issued to Donald E. Weder on Jan. 26, 1993, the specification of which is hereby expressly incorporated herein by reference.

The term “bonding material” when used herein can mean an adhesive, frequently a pressure sensitive adhesive, or a cohesive or any adhesive/cohesive combination, having adhesive qualities (i.e., qualities of adhesion or adhesion/cohesion, respectively) sufficient to cause the attachment of a portion of the sheet of material to itself, to a floral grouping, or to a flower pot. Since the bonding material may comprise either an adhesive or an adhesive/cohesive combination, it will be appreciated that both adhesives and cohesives are known in the art, and both are commercially available. When the bonding material is a cohesive, a similar cohesive material must be placed on the adjacent surface for bondingly contacting and bondingly engaging with the cohesive material. The term “bonding material” also includes materials which are heat sealable and, in this instance, the adjacent portions of the material must be brought into contact and then heat must be applied to effect the seal. The term “bonding material” also includes materials which are sonic sealable and vibratory sealable. The term “bonding material” when used herein also means a heat sealing lacquer or hot melt material which may be applied to the material and, in this instance, heat, sound waves, or vibrations, also must be applied to effect the sealing.

The term “bonding material” when used herein also means any type of material or thing which can be used to effect the bonding or connecting of two adjacent portions of the material or sheet of material to effect the connection or bonding described herein. The term “bonding material” may also include ties, labels, bands, ribbons, strings, tapes (including single or double-sided adhesive tapes), staples or combinations thereof. Some of the bonding materials would secure the ends of the material while other bonding material may bind the circumference of a wrapper, or a sleeve, or, alternatively and/or in addition, the bonding materials would secure overlapping folds in the material and/or sleeve. Another way to secure the wrapping and/or sleeve is to heat seal the ends of the material to another portion of the material. One way to do this is to contact the ends with an iron of sufficient heat to heat seal the material.

Alternatively, a cold seal adhesive may be utilized as the bonding material. The cold seal adhesive adheres only to a similar substrate, acting similarly as a cohesive, and binds only to itself. The cold seal adhesive, since it bonds only to a similar substrate, does not cause a residue to build up on equipment, thereby both permitting much more rapid disposition and use of such equipment to form articles and reducing labor costs. Further, since no heat is required to effect the seal, the dwell time, that is, the time for the sheet of material to form and retain the shape of an article, such as a flower pot cover or flower pot, is reduced. A cold seal adhesive binds quickly and easily with minimal pressure, and such a seal is not readily releaseable. This characteristic is different from, for example, a pressure sensitive adhesive.

The term “bonding material” when used herein also means any heat or chemically shrinkable material, and static electrical or other electrical apparatus, chemical welding apparatus, magnetic apparatus, mechanical or barb-type fastening apparatus or clamps, curl-type characteristics of the film or materials incorporated in material which can cause the material to take on certain shapes, cling films, slots, grooves, shrinkable materials and bands, curl materials, springs, and any type of welding method which may weld portions of the material to itself or to the pot, or to both the material itself and the pot.

The bonding material 35, if present, may have a backing or release strip (not shown). The backing or release strip may be left applied for a period of time to the bonding material 35 after it is disposed on a surface of the sheet of material 10 prior to its use as a wrapping material, to protect the bonding qualities of the bonding material 35.

In one embodiment of the invention, the sheet of material 10 has a printed pattern 36 on at least a portion of at least one of the upper and lower surfaces 14 and 16 of the sheet of material 10, such as the lower surface 16 thereof as shown in FIGS. 1 and 4-6. The printed pattern 36 may be of any color, geometrical shape, design, image or word, or any combination thereof.

By way of example, the printed pattern 36 may be a floral pattern generally associated with botanical items, a color of a floral item, a word identifying a floral item, or any combination thereof. The printed pattern 36 may cover only a portion of the sheet of material 10, or may cover one entire surface of the sheet of material 10, or may cover both upper and lower surfaces 14 and 16 of the sheet of material 10.

The ink compositions applied to the sheet of material 10 to provide the printed pattern 36 can be any ink compositions, either solvent-based or water-based, which are compatible with the sheet of material 10. Such ink compositions are well known in the printing art; however, for environmental reasons it is preferred that the ink compositions be water-based ink compositions. Water-based ink compositions which can be employed to produce the printed pattern 36 on the sheet of material 10, are disclosed in U.S. Pat. No. 5,594,048 issued to Weder et al. on Jan. 14, 1997, the specification of which is hereby expressly incorporated in its entirety herein by reference.

The ink compositions may be applied to the sheet of material 10 in any conventional manner. The method of application may be manual or mechanical. If the material is in the form of a roll, then gravure, flexographic procedures or Mayer rod procedures may be used to apply the ink compositions to the material which, when cut into sheets of material 10, provide the sheets of material 10 having the printed pattern 36 thereon.

The scent disposed on the sheet of material 10 can be a scent commonly associated with a floral item and/or color of a floral item represented by the printed pattern on the sheet of material 10, or the scent disposed on the sheet of material 10 can be a scent commonly associated with an object contained within the scented decorative package formed from the sheet of material 10. For example, a decorative cover for a flower pot or floral grouping or a sleeve having a scent corresponding to the scent of a rose disposed thereon, could have an image or graphic of a rose, a color of a particular rose, or the word “rose” disposed thereon or such decorative cover or sleeve may have a rose disposed therein.

The term “scent” as used herein refers to any odor or combination of odors normally associated with a floral item, which is desired for a particular application. Examples of such scents include odors normally associated with flowers, plants, grasses, woods, roots and the like. Such scents are known in the art and are commercially available.

The scent 12 may be applied to the sheet of material 10 simultaneously with the application of the printed pattern 36, such as by incorporation of the scent 12 in an ink or foamable ink which is printed on the sheet of material 10 or a lacquer or foamable lacquer which is disposed on the sheet of material 10 to provide the printed pattern 36 containing the scent 12.

Alternatively, the scent 12 may be applied to the sheet of material 10 prior to or following application of the printed pattern 36. The scent 12 may be contained within a lacquer, or other liquid, before it is disposed upon the sheet of material 10. The scent 12 may also be contained within a dye, ink, and/or pigment (not shown). Such dyes, inks and pigments are known in the art, and are commercially available, and may be disposed upon or incorporated in the sheet of material 10 by any method described herein or known in the art.

The scent 12 may be disposed upon the sheet of material 10 either before the sheet of material 10 is formed into a decorative cover or decorative sleeve or after the sheet of material 10 is formed into a decorative cover or decorative sleeve. The scent 12 can be incorporated into the sheet of material 10 by spraying the scent 12 thereupon, painting the scent 12 thereupon, brushing the scent 12 thereupon, lacquering the scent 12 thereupon, immersing the sheet of material 10 in a scent-containing liquid, exposing the sheet of material 10 to scent-containing gas, or any combination thereof.

The scent 12 may be disposed on a portion of the upper surface 14 and/or the lower surface 16 of the sheet of material 10 such that the scent 12 may be provided on an outer surface or an inner surface of a scented decorative cover, that is, it may be desired to place the scent 12 on a portion of the upper surface 14 of the sheet of material 10, and therefore an inner surface of a decorative cover formed therefrom, so that the scent 12 is in close approximation to the floral grouping 34, and so that none of the scent 12 will rub off on the hands of a person carrying the decorative cover or on a transport or display container in which the decorative cover is disposed. Alternatively, it may be desired to place the scent 12 on a portion of the lower surface 16 of the sheet of material 10, and therefore on an outer surface of a decorative cover formed therefrom, so that the scent 12 is not wrapped within the decorative cover but is exposed, thereby releasing more of the scent 12, and also so that detrimental interactions between the floral grouping 34 and the chemical components of the scent 12 are minimized.

The scent 12 may also be incorporated into the sheet of material 10 during the formation of the sheet of material 10. For example, if the sheet material 10 is a synthetic polymeric film, the scent 12 may be incorporated during the extrusion process. The extrusion of polymeric films is well-known in the art.

An insecticide may also be mixed with the scent 12. It will be appreciated that insecticides are also well-known in the art and commercially available. Such insecticides may be disposed upon or incorporated in the sheet of material 10 by any method described herein, or known in the art. Further, the scent 12 or the insecticide or both may be mixed with a bonding material.

The scent 12 applied to the sheet of material 10 may be indicative of a characteristic of an intended use of the sheet of material 10. For example, the sheet of material 10 formed into a decorative cover or sleeve for a floral grouping or flower pot may be scented with an odor and/or color normally associated with the particular flower or floral item to be disposed in the decorative cover or sleeve such as roses, lilacs, gardenias, wisteria, hydrangea, honeysuckle, and the like, or a particular plant, such as aloe vera, mint, eucalyptus or evergreen.

Further, the sheet of material 10 may also be scented with an odor normally associated with a particular type of cloth which the sheet of material 10 simulates in texture and appearance. For example, raw silk has a unique texture as well as odor, and when the sheet of material 10 is provided with a texture and appearance simulating raw silk, the sheet of material 10 may be scented with the odor normally associated with raw silk.

Examples of scents utilized herein include, but are not limited to, floral scents, such as flower blossoms, leaves, petals, stems, roots or any portion of a plant. Additional examples of scents include flowers (such as roses, daisies, lilacs), plants and the like, or any combination of the foregoing. Such scents are known in the art, and are commercially available from such places as Horizon Aromatics, Wilmington, Del.

In the embodiments shown in the drawings, the sheet of material 10 having the printed pattern 36 and the scent 12 thereon has a rectangular configuration. It will be appreciated, however, that the sheet of material 10 having the printed pattern 36 and the scent 12 disposed thereon can be of any shape, configuration or size as long as the sheet of material 10 is sufficiently sized and shaped to wrap and encompass a flower pot or a floral grouping. For example, the sheet of material 10 may have a square, round, oval, octagonal or asymmetrical configuration. Further, multiple sheets of material 10 may be used in a single circumstance to provide a scented decorative cover or scented sleeve for a flower pot or a floral grouping. Moreover, when multiple sheets of material 10 are used in combination, the sheets of material 10 need not be uniform in size or shape. Finally, it will be appreciated that the sheet of material 10 having the printed pattern 36 and the scent 12 shown in all embodiments herein is a substantially flat sheet and the ink compositions applied to the sheet of material 10 are of substantially uniform thickness.

Any thickness or stiffness of the sheet of material 10 may be utilized in accordance with the present invention as long as the sheet of material 10 having the printed pattern 36 and the scent 12 thereon may be wrapped about at least a portion of a flower pot or a floral grouping, as described herein. A stiffer sheet of material 10 may be used if such stiffer sheet of material 10 is scored to facilitate folding. The sheet of material 10 can have a thickness of from about 0.1 mil to about 30 mils. Typically, however, the sheet of material 10 has a thickness in a range of about 0.5 mil to about 2.5 mils.

The sheet of material 10 is constructed from any suitable material that is capable of being wrapped about a flower pot or floral grouping and scented. Preferably, the sheet of material 10 is paper (untreated or treated in any manner), metal foil, polymeric film, fabric (woven or nonwoven or synthetic or natural), cardboard, burlap, or laminations or combinations thereof.

The term “polymeric film” when used herein means a synthetically derived polymer, such as a polypropylene or polyethylene, or a naturally occurring polymer such as cellophane. A polymeric film is relatively strong and not as subject to tearing (substantially non-tearable), as might be the case with paper or foil.

The sheet of material 10 may also be constructed, in whole or in part, from a cling material. The cling material is constructed from polyethylene such as Cling Wrap made by Glad®, First Brands Corporation, Danbury, Conn., and treated if necessary. The thickness of the cling material will, in part, depend upon the size of sleeve and the size of the flower pot in the sleeve, i.e., generally, a larger flower pot may require a thicker and therefore stronger cling material. The cling material will have a thickness of at least about 0.1 mil, and preferably a thickness of from about 0.5 mil to about 2.5 mils. However, any thickness of cling material may be utilized in accordance with the present invention which permits the cling material to be printed with ink compositions and scented so as to provide the cling material with the printed pattern 36 and the scent 12.

“Cling Wrap or Material” when used herein means any material which is capable of connecting to the sheet of material and/or itself upon contacting engagement during the wrapping process and is wrappable about an item whereby portions of the cling material contactingly engage and connect to other portions of another material, or, alternatively, itself, for generally securing the material wrapped about at least a portion of a flower pot. This connecting engagement is preferably temporary in that the material may be easily removed, i.e., the cling material “clings” to the flower pot.

In one embodiment, a scented sleeve may be constructed from two polypropylene films wherein at least a portion of a lower surface or outer surface of one of the sheets of polypropylene film is provided with the printed pattern 36 and the scent 12. The sheets of polypropylene film having such printed pattern 36 and the scent 12 may be connected together or laminated or may be separate sheets. In an alternative embodiment, the scented sleeve may be constructed from only one sheet of polypropylene film having the printed pattern 36 and the scent 12 thereon or therein.

The sheet of material 10 may vary in color. Further, the sheet of material 10 may be provided with other decorative patterns or designs in addition to the printed pattern 36 and the scent 12 which are printed, etched, and/or embossed thereon. In addition, the sheet of material 10 may have various colorings, coatings, flocking and/or metallic finishes, applied separately or simultaneously or may be characterized totally or partially by pearlescent, opaque, translucent, transparent, tinted, iridescent or the like, qualities. Each of the above-named characteristics may occur alone or in combination. Moreover, each surface of the sheet of material 10 may vary in the combination of such characteristics.

A plurality of sheets of material 10 may be connected together to form a roll as shown in U.S. Pat. No. 5,459,976 issued to Donald E. Weder on Oct. 24, 1995, the specification of which is hereby expressly incorporated herein in its entirety by reference.

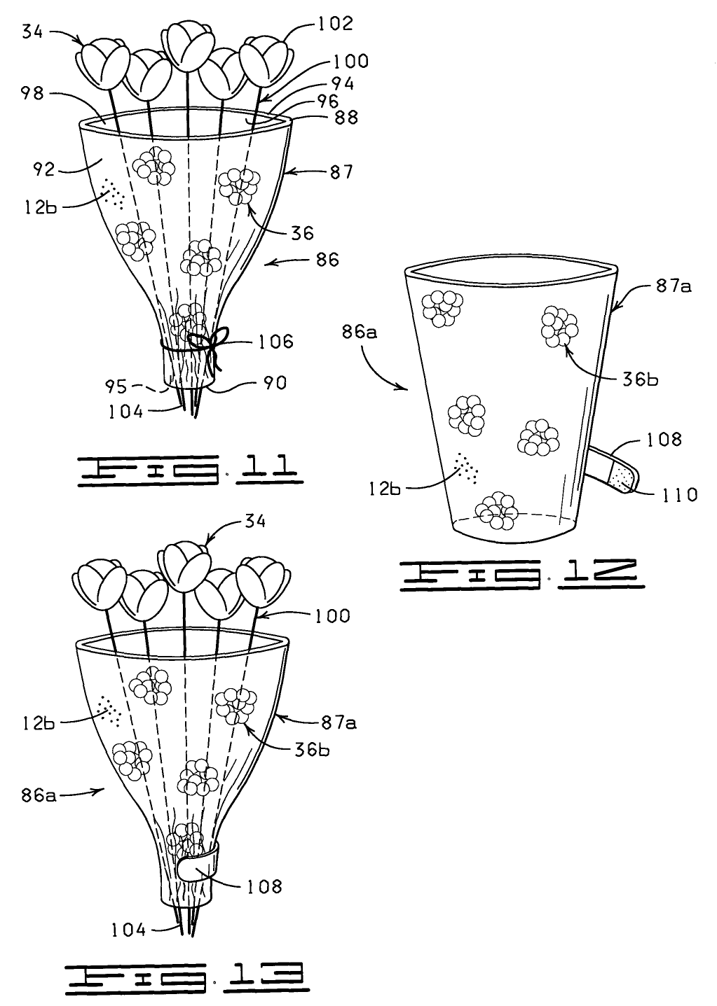

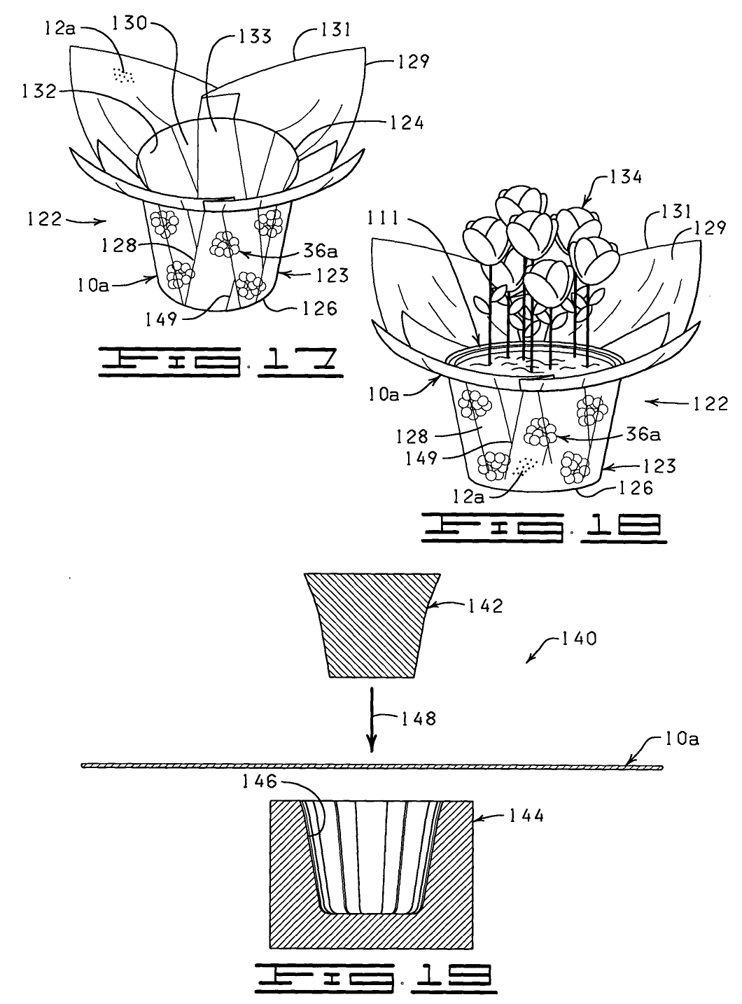

The sheet of material 10 having the printed pattern 36 and the scent 12 disposed thereon may be employed to provide a decorative cover for a floral grouping (FIGS. 3-6) or a decorative cover for a flower pot (FIGS. 7-8); or the sheet of material 10 may be employed to provide a sleeve for wrapping or covering a floral grouping 34 (FIGS. 11 and 13) or a flower pot (FIGS. 15-16); or the sheet of material 10 may be employed to form a preformed flower pot cover 122 for covering a flower pot (FIGS. 17 and 18). The use of the sheet of material 10 having the printed pattern 36 with the scent 12 to form a scented decorative cover for a floral grouping or a flower pot, to form a scented sleeve for a floral grouping or a flower pot, or to form a scented preformed flower pot cover will be described in more complete detail hereinafter.

Referring now to FIGS. 3-6, the wrapping of the sheet of material 10 having the printed pattern 36 and the scent 12 thereon about the floral grouping 34 to provide a scented decorative cover 37 for the floral grouping 34 will now be described. The sheet of material 10 (which is illustrated as having the strip of bonding material 35 disposed upon the upper surface 14 of the sheet of material 10 substantially adjacent the fourth side 26 of the sheet of material 10) is provided, either as an individual sheet or from a pad or a roll.

In operation, an operator disposes the sheet of material 10 on a support surface (not shown), such that the lower surface 16 of the sheet of material 10 contacts the support surface. The floral grouping 34, having an upper bloom or foliage portion 42 and a lower stem portion 44, is then placed on the upper surface 14 of the sheet of material 10 in a diagonal orientation (FIG. 3).

The sheet of material 10 is then wrapped about the floral grouping 34 by the operator, the operator overlapping a portion of the sheet of material 10 over another portion of the sheet of material 10. That is, for example, the operator places the first side 20 of the sheet of material 10 over the floral grouping 34, as shown in FIG. 4. The operator continues to roll the floral grouping 34 and the sheet of material 10 in the direction toward the second side 22 of the sheet of material 10 until the upper surface 14 of the sheet of material 10 near the fourth side 26 firmly engages the lower surface 16 of the sheet of material 10, whereby the floral grouping 34 is substantially encompassed by the sheet of material 10, and wherein the bonding material 35 contacts a portion of the overlapped sheet of material 10 to secure the sheet of material 10 in a wrapped condition about the floral grouping 34 and provide the scented decorative cover 37 shown in FIG. 5 which substantially encompasses and surrounds a substantial portion of the floral grouping 34. FIG. 5 shows the floral grouping 34 wrapped in a conical fashion with the bloom portion 42 of the floral grouping 34 exposed substantially adjacent an open upper end 45 of the scented decorative cover 37 and the lower stem portion 44 of the floral grouping 34 exposed substantially adjacent a lower end 46 of the scented decorative cover 37.

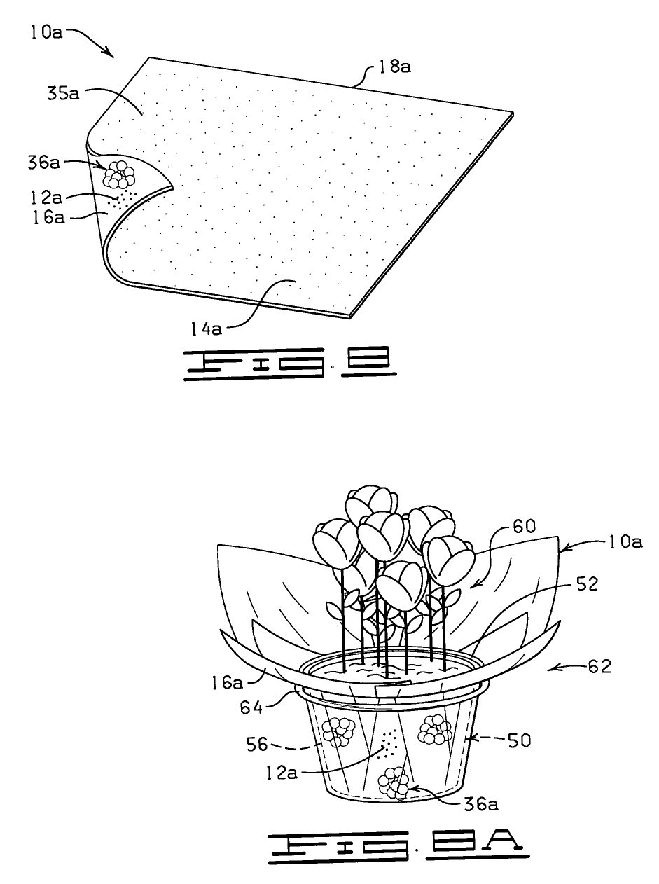

In another embodiment, illustrated in FIG. 6, the sheet of material 10 having the printed pattern 36 and the scent 12 disposed thereon is utilized to wrap the floral grouping 34 in an alternative method of wrapping. The floral grouping 34 is disposed upon the sheet of material 10 approximately parallel to the third side 24 of the sheet of material 10. The sheet of material 10 is then wrapped generally about the lower stem portion 44 of the floral grouping 34 to a position wherein the fourth side 26 of the sheet of material 10 generally overlaps the third side 24 of the sheet of material 10 in a cylindrical fashion. It should be noted that the sheet of material 10 may be wrapped a plurality of times about the stem portion 44 of the floral grouping 34 before the overlapping of the third side 24 and the fourth side 26 of the sheet of material 10. As before, the portion of the sheet of material 10 near the fourth side 26 is disposed generally adjacent another portion of the sheet of material 10, and the two adjacent portions then are brought into contact where they may be bondingly engaged by the bonding material 35, thereby securing the sheet of material 10 generally about the floral grouping 34 so as to provide a decorative cover 37a for the floral grouping 34.

Shown in FIG. 7 is a flower pot designated by the reference numeral 50, which has an open upper end 52, a bottom end 54, an outer peripheral surface 56, and an inner retaining space 58 within which may be disposed a growing medium. The flower pot 50 may contain a botanical item, such as a plant 60.

The term “flower pot” as used herein refers to any type of container for holding a floral grouping or floral item, or a plant, or even another pot type container. Examples of flower pots and/or pot type containers include, but are not limited to, clay pots, wooden pots, plastic pots, pots made from natural mad/or synthetic fibers, or any combination thereof. Such flower pots and or pot-type containers are provided with a retaining space for receiving a floral grouping or floral item. The floral grouping or floral item may be disposed within the retaining space of the flower pot with a suitable growing medium described in further detail below, or other retaining medium, such as a floral foam. It will also be understood that in some cases the floral grouping or floral item, and any appropriate growing medium or other retaining medium, may be disposed in a sleeve formed from the sheet of material having the pattern printed thereon if the sleeve is adapted to contain a medium.

Referring now to FIG. 8, shown therein is a sheet of material 10a similar to the sheet of material 10 except the sheet of material 10a can be devoid of bonding material or a bonding material 35a may be disposed at least a substantially central portion of a upper surface 14a of the sheet of material 10a. The sheet of material 10a has the upper surface 14a, a lower surface 16a and an outer peripheral edge 18a. The sheet of material 10a has a printed pattern 36a and the scent 12a thereon and may be used to form a scented decorative cover 62 (FIG. 8a) about the flower pot 50, the preformed pot cover 122 (FIG. 17) or a scent decorative cover for any pot-type container.

Referring now to FIG. 8a, the sheet of material 10a having the printed pattern 36a and the scent 12a thereon may be wrapped about the flower pot 50 by any one of numerous methods used to wrap sheets of material about flower pots to form the decorative pot cover 62 for the flower pot 50. The sheet of material 10a may, for example, be formed by hand about the outer peripheral surface 56 of the flower pot 50 to produce the scented decorative cover 62. The scented decorative cover 62 is then secured about the flower pot 50 by an elastic band 64 so that the open upper end 52 of the flower pot 50 remains substantially uncovered by the scented decorative cover 62.

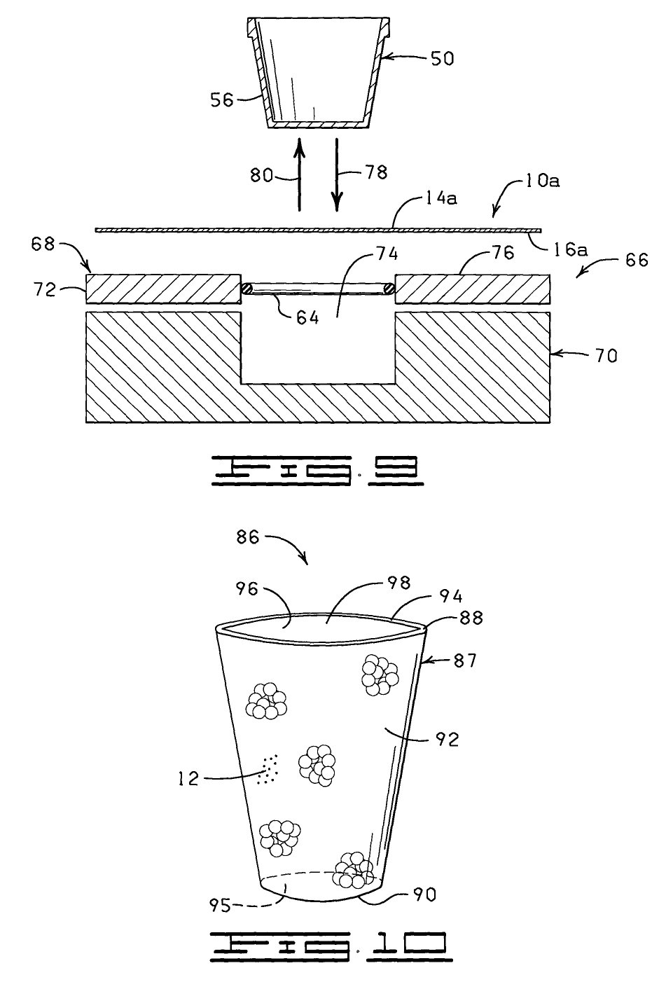

Referring now to FIG. 9, a flower pot cover former and band applicator apparatus 66 for forming the sheet of material 10a having the printed pattern 36a (FIG. 8) and the scent 12a (FIG. 8) thereon, into the scented decorative cover 62 (FIG. 8a) for the flower pot 50 is illustrated. The flower pot cover former and band applicator apparatus 66 includes a band applicator 68 and a flower pot cover former 70. The flower pot cover former and band applicator apparatus 66 has a support platform 72 with an opening 74 formed therein. A band, such as the elastic band 64, is disposed circumferentially about the opening 74 in the support platform 72.

The sheet of material 10a is positioned on an upper surface 76 on the support platform 72 such that the sheet of material 10a is positioned over the opening 74 in the support platform 72. The flower pot 50 is then positioned above the sheet of material 10a and is moved in a direction 78 into the opening 74 of the flower pot cover former and band applicator apparatus 66. As the flower pot 50 is moved into the opening 74, the sheet of material 10a is pressed about the outer peripheral surface 56 of the flower pot 50 thereby forming the scented decorative cover 62 (FIG. 8a) about the flower pot 50. The scented decorative cover 62 is then secured about the flower pot 50 by the elastic band 64. The flower pot 50 having the scented decorative cover 62 secured thereto is then moved in a direction 80 out of the opening 74 in the support platform 72.

The elastic band 64 can be applied manually or automatically such as by the method shown in U.S. Pat. No. 5,105,599 issued to Donald E. Weder on Apr. 21, 1992, which is hereby expressly incorporated herein by reference. The elastic band 64 can be applied as a tie using a method such as described in U.S. Pat. No. 5,609,009 issued to Weder et al. on Mar. 11, 1997, the specification of which is hereby expressly incorporated herein by reference. The sheet of material 10a having the printed pattern 36a and the scent 12a disposed thereon, can be applied automatically about the flower pot 50, for example, by methods shown in U.S. Pat. No. 4,733,521 issued to Weder et al. on Mar. 29, 1988 and U.S. Pat. No. 5,291,721 issued to Weder et al. on Mar. 8, 1994, both of which are hereby expressly incorporated herein by reference.

Instead of, or in addition to, securing the scented decorative cover 62 about the flower pot 50 via the elastic band 64, the scented decorative cover 62 formed from the sheet of material 10a may be secured to the flower pot 50 by the use of one or more bonding materials. For example, the upper surface 14a of the sheet of material 10a may have a bonding material 35a disposed upon a portion thereof. When the sheet of material 10a is disposed about the flower pot 50, at least a portion of the upper surface 14a of the sheet of material 10a contacts the outer peripheral surface 56 of the flower pot 50 and is thereby bonded and held about the flower pot 50 via the bonding material 35a.

The bonding material 35a may cover a portion of the upper surface 14a of the sheet of material 10a or the bonding material 35a may entirely cover the upper surface 14a of the sheet of material 10a. The bonding material 35a may be disposed on the upper surface 14a of the sheet of material 10a in the form of a strip or in the form of spaced-apart spots. One method for disposing a bonding material on a sheet of material is described in U.S. Pat. No. 5,111,637 issued to Weder et al. on May 12, 1992, which is expressly incorporated herein by reference.

Shown in FIGS. 10 and 11 is a scented decorative cover 86 which comprises a flexible bag or sleeve 87 of unitary construction. The sleeve 87 may be used to provide the scented decorative cover 86 for the floral grouping 34 or the flower pot 50 (FIG. 7). The sleeve 87 initially comprises a flexible flat collapsed piece of material which is openable in the form of a tube or sleeve. Such sleeves are well known in the floral industry. The sleeve 87 has an upper end 88, a lower end 90, an outer peripheral surface 92 and an inner peripheral surface 93. The sleeve 87 may be tapered outwardly from the lower end 90 toward a larger diameter at its upper end 88. In its flattened state, the sleeve 87 generally has an overall trapezoidal or modified trapezoidal shape, and when opened, is substantially frusto-conical to coniform. It will be appreciated, however, that the sleeve 87 may have variations on the aforementioned shapes or may have significantly altered shapes such as square, rectangular, or cylindrical as long as the sleeve 87 functions in accordance with the present invention in the manner described herein. The sleeve 87 (or any other sleeve disclosed herein) may have an angular or contoured shape. The sleeve 87 may comprise any shape, whether geometric, non-geometric, asymmetrical and/or fanciful as long as it functions in accordance with the present invention. The sleeve 87 may also be equipped with drain holes (if having a closed bottom) or side ventilation holes (not shown), or can be made from gas permeable or impermeable materials.

The sleeve 87 has an opening 94 at the upper end 88 and an opening 95 at the lower end 90. The inner peripheral surface 96 of the sleeve 87, when the sleeve 87 is opened, defines and encompasses an inner retaining space 98. Although the sleeve 87 is shown and described as having an opening 95 at the lower end, those skilled in the art will understand that a portion of the lower end 90 may be inwardly or outwardly folded to form one or more gussets (not shown) hereby providing a closed lower end and allowing the lower portion of the inner retaining space 98 to be expandable, for example, for receiving the circular bottom of a pot or growing medium.

The printed pattern 36 is disposed on at least a portion of the inner and/or outer peripheral surfaces 92 and 96 of the sleeve 87. The scent 12b is disposed on at least a portion of the inner and/or outer peripheral surfaces 92 and 96 of the sleeve 87. The material from which the sleeve 87 is constructed is similar to the sheet of material 10 herein before described. Such materials used to construct the sleeve 87 are further described in U.S. Pat. No. 5,111,637 issued to Weder et al. on May 12, 1992, which is expressly incorporated herein by reference. Any thickness of material may be utilized in accordance with the present invention as long as the sleeve 87 may be scented and formed as described herein, and as long as the formed sleeve 87 may contain at least a portion of a flower pot or a floral grouping, as described herein. Additionally, an insulating material such as bubble film, preferable as one of two or more layers, can be utilized in order to provide additional protection for the item, such as the floral grouping 34, contained therein.

Referring again to FIG. 11, a floral grouping 100 is disposed within the inner retaining space 98 of the sleeve 87 and the sleeve 87 is cinched about the floral grouping 100 to provide the scented decorative cover 86 for the floral grouping 100. Generally, an upper or bloom portion 102 of the floral grouping 100 is exposed substantially adjacent the opening 94 of the sleeve 87 and a lower or stem portion 104 of the floral grouping 100 is exposed substantially adjacent the lower end 90 of the sleeve 87. Either end of the sleeve 87 may be closed about the floral grouping 100, however, usually a portion of the sleeve 87 is tightened about a portion of the stem portion 104 of the floral grouping 100 in order to hold the sleeve 87 about the floral grouping 100. The sleeve 87 may be held by a tie 106 tied about the sleeve 87 such as is shown in FIG. 11, or other methods for binding the sleeve 87 about a floral grouping may be employed, such as the bonding materials described elsewhere herein.

Similarly, it may generally be desired to use the sleeve 87 as the scented decorative cover 62 for a flower pot (not shown). The flower pot will generally contain a botanical item or plant. The flower pot can be deposited into the open sleeve 87 in a manner well known in the art, such as manually wherein the sleeve 87 is opened by hand and the flower pot deposited therein.

As noted above, a bonding material may be disposed on a portion of the sleeve 87 or any sleeve described herein to assist in holding the sleeve 87 to the flower pot when the flower pot is disposed within the sleeve 87 or to assist in closing the upper end 88 of the sleeve 87, as will be discussed in further detail below.

The bonding material may be disposed upon either the outer peripheral surface 92 or the inner peripheral surface 96 of the sleeve 87, as well as upon the flower pot. Further, the bonding material may be disposed as a strip or block or spots of bonding material, or in any other geometric, non-geometric, asymmetric, or fanciful form, and in any pattern including covering either the entire inner peripheral surface 96 and/or outer peripheral surface 92 of the sleeve 87 and/or the flower pot. The bonding material may be covered by a cover or release strip which can be removed prior to the use of the sleeve 87. The bonding material can be applied by methods known to those of ordinary skill in their art. One method for disposing a bonding material, in this case an adhesive, is described in U.S. Pat. No. 5,111,637 issued to Weder et al. on May 12, 1992, which is hereby expressly incorporated herein by reference.

As noted above, a bonding material may be disposed on at least a portion of the inner peripheral surface 96 of the sleeve 87 (or any other sleeve described herein), or, alternatively, the bonding material 35 may be disposed on an outer peripheral surface of a flower pot contained within the sleeve 87, while the sleeve 87 may be free of the bonding material. In a further alternative, the bonding material may be disposed both on at least a portion of the flower pot 50 as well as upon at least a portion of the inner peripheral surface 96 of the sleeve 87. In addition, a portion of the bonding material may also be disposed on the outer peripheral surface 92 of the sleeve 87 as well. The bonding material, when present, is disposed on the sleeve 87 and/or flower pot by any method known in the art.

Certain embodiments of sleeves described herein may be used in combination with a preformed pot cover. For example, a preformed pot cover may be applied to the pot, then the covered pot wrapped or disposed within a sleeve. Either the cover, the sleeve, or both, may have a printed pattern and a scent disposed thereon.

As shown in FIG. 12, a scented decorative cover 86a is provided which comprises a sleeve 87a having a printed pattern 36b and a scent 12b disposed thereon. The sleeve 87a is further provided with a cinching tab 108 having a bonding material 110 disposed upon a surface thereof. The cinching tab 108 can be used to gather portions of the scented sleeve 87a together about the stem portion 104 of the floral grouping 100 as shown in FIG. 13 for holding the sleeve 87a tightly about the floral grouping 100.

Examples of sleeves which may be used in the practice of the present invention are disclosed in U.S. Pat. No. 5,625,979 issued to Donald E. Weder on May 6, 1997, which is expressly incorporated herein by reference in its entirety. Equipment and devices for forming sleeves are commercially available, and well known in the art.

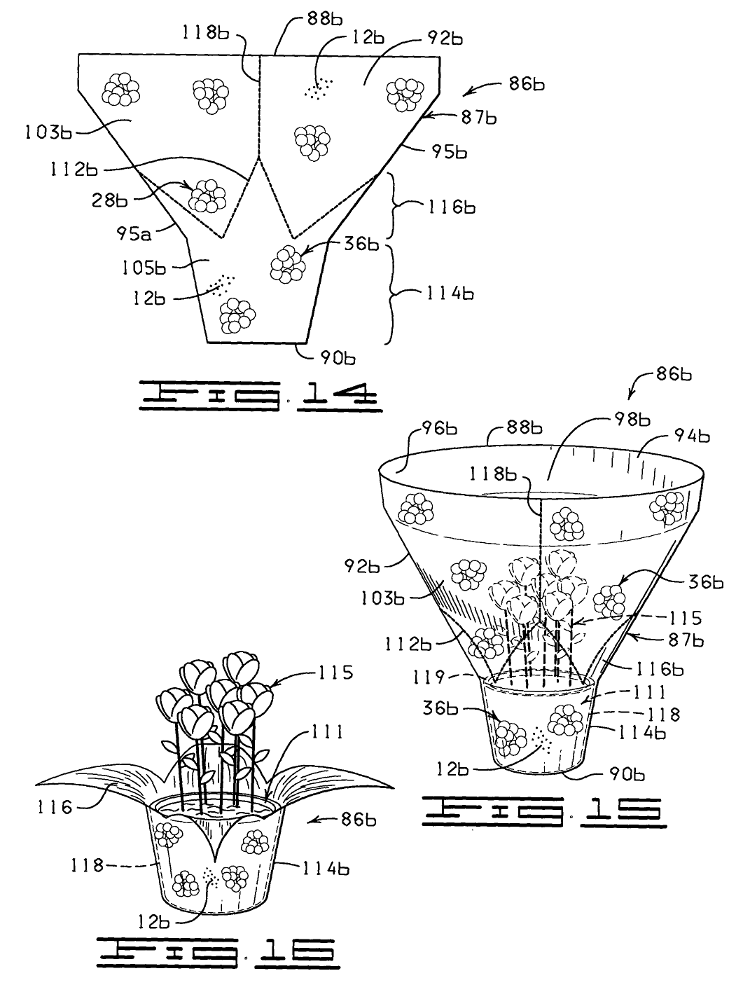

Shown in FIGS. 14 and 15 is another embodiment of a scented decorative cover 86b which comprises a sleeve 87b constructed in accordance with the present invention. The sleeve 87b has a printed pattern 36b and a scent 12b disposed thereon; and the sleeve 87b has a “detaching” element 112 in predetermined areas for detaching a portion of the sleeve 87b. The sleeve 87b generally initially comprises a flexible, flat, collapsed, piece of material which is openable in the form of a tube or sleeve. The sleeve 87b is constructed of similar material and in a similar way as described previously herein and may be described similar to the other sleeves described herein except for the additional elements described herein.

“Detaching element” as used herein, means any element, or combination of elements, or features, such as, but not by way of limitation, perforations, tear strips, zippers, and any other devices or elements of this nature known in the art, or any combination thereof. Therefore, while perforations are shown and described in detail herein, it will be understood that tear strips, zippers, or any other “detaching elements” known in the art, or any combination thereof, could be substituted therefor and/or used therewith.

The sleeve 87b has an upper end 88b, a lower end 90b, and an outer peripheral surface 92b. The sleeve 87b has an opening 94b at the upper end 88b thereof wherein an open condition, as shown in FIG. 15, and the sleeve 87b may be open at the lower end 90b, or the lower end 90b of the sleeve 87b may be closed. In a flattened state, the sleeve 87b has a first side 95a and a second side 95b. The sleeve 87b also has an inner peripheral surface 96b which, when the sleeve 87b is opened, defines and encompasses an inner retaining space 98b as shown in FIG. 15. When the lower end 90b of the sleeve 87b is closed, a portion of the lower end 90b may be inwardly folded to form one or more gussets (not shown) for permitting a circular bottom of an object, such as a flower pot 111 (see FIGS. 15 and 16), to be disposed in the inner retaining space 98b of the sleeve 87b.

As shown in FIGS. 14 and 15, the sleeve 87b is demarcated into an upper portion 103b and a lower portion 105b. The lower portion 105b of the sleeve 87b is generally sized to contain the flower pot 111. The upper portion 103b of the sleeve 87b is sized to substantially surround and encompass a floral grouping 115 contained in the flower pot 111 which is disposed within the lower portion 105b of the sleeve 87b. The sleeve 87b is demarcated into the upper portion 103b and the lower portion 105b by the detaching element 112b for enabling the detachment of the upper portion 103b of the sleeve 87b from the lower portion 105b of the sleeve 87b. In the present embodiment, the detaching element 112b is a plurality of generally laterally-oriented or alternately diagonally-oriented perforations which extend circumferentially across the outer peripheral surface 92b of the sleeve 87b from the first side 95a to the second side 96b thereof.

As shown in FIGS. 14 and 15, the lower portion 105b of the sleeve 87b further comprises a base portion 114b and a skirt portion 116b. The base portion 114b comprises that part of the lower portion 105b of the sleeve 87b which, when the flower pot 111 is placed into the lower portion 105b, has an inner peripheral surface which is substantially adjacent to and surrounds an outer peripheral surface 118 of the flower pot 111. The skirt portion 116b comprises that part of the lower portion 105b of the sleeve 87b which extends beyond an open upper end 119 of the flower pot 111 and surrounds at least a portion of the floral grouping 115 contained within the flower pot 111 and which is left to freely extend at an angle, inwardly or outwardly, from the base portion 114b when the upper portion 103b of the sleeve 87b is detached from the lower portion 105b of the sleeve 87b by actuation of the detaching element 112b.

In the intact sleeve 87b, the skirt portion 116b comprises an upper peripheral edge congruent with the detaching element 112b which is connected to a lower peripheral edge, also congruent with the detaching element 112, of the upper portion 103b of the sleeve 87b. In FIGS. 14 and 15, the upper peripheral edge of the skirt portion 116b is congruent with the alternating diagonally-oriented lines of perforations which form a zig-zag and comprise the detaching element 112b. The upper portion 103b of the sleeve 87b may also have an additional detaching element 118b indicated as a plurality of vertical perforations for facilitating removal of the upper portion 103b of the sleeve 87b and which are disposed more or less vertically therein extending between the detaching element 112b and the upper end 88b of the sleeve 87b.

The upper portion 103b of the sleeve 87b is thereby separable from the lower portion 105b of the sleeve 87b by tearing the upper portion 103b along both the detaching element 112b and the detaching element 118b, thereby separating the upper portion 103b from the lower portion 105b of the sleeve 87b. The lower portion 105b of the sleeve 87b remains disposed as the base portion 114b about the flower pot 111, and as the skirt portion 116b about the floral grouping 115, thereby forming the decorative cover 86b as shown in FIG. 16 which substantially surrounds and encompasses the flower pot 111 and the floral grouping 115 contained therein. A printed pattern 36b may be printed upon only the lower portion 105b of the sleeve 87b, for example, the base and skirt portions 114b and 116b, while the upper portion 103b can be unprinted, or the upper portion 103b of the sleeve 87b can be printed with a printed pattern different from the printed pattern 36b on the lower portion 114b of the sleeve 87b.

In a general method of use of sleeve 87b as the decorative cover 86b for the flower pot 111, an operator provides the sleeve 87b and the flower pot 111 having the floral grouping 115 disposed in a growing medium contained within the flower pot 111. The operator then disposes the flower pot 111 having the floral grouping 115 contained therein into the sleeve 87b by opening the sleeve 87b at its upper end 88b and assuring both that the opening 94b therein is in an open condition and that the inner peripheral surface 96b of the sleeve 87b is somewhat expanded outward as well, as shown in FIG. 15. The operator then manually or automatically disposes the flower pot 111 into the opening 94b in the sleeve 87b, the flower pot 111 being disposed generally through the upper portion 103b of the sleeve 87b into generally the lower portion 105b of the sleeve 87b, the flower pot 111 remaining in the lower portion 105b of the sleeve 87b, permitting the sleeve 87b to substantially surround and tightly encompass the flower pot 111. It will be understood that, alternatively, the sleeve 87b may be provided within extension (not shown) such that the sleeve 87b may be disposed on rods, or wickets (not shown), and the flower pot 111 may be disposed in the sleeve 87b either before or after the sleeve 87b has been removed from the rods or wickets.

Referring now to FIGS. 17 and 18, a decorative preformed flower pot cover 122 is illustrated constructed from a sheet of material 10a. The sheet of material 10a (shown in FIG. 8) is similar to the sheet of material 10 except the bonding material on the sheet of material 10a is not necessarily disposed in the form of the strip of bonding material 35 illustrated in FIGS. 2 and 3. The decorative preformed flower pot cover 122 may be constructed of the single sheet of material 10a or a plurality of layers of the same and/or different types of material may be employed in the formation of the decorative preformed flower pot cover 122. If multiple sheets of material are utilized to form the decorative preformed flower pot cover 122, each sheet of material, may be provided with the printed pattern 36a and the scent 12a thereon, or only one of the multiple sheets of material may be provided with the printed pattern 36a and the scent 12. Alternatively, one of the multiple sheets of material may be provided with the printed pattern 36a and another sheet of material may be provided with the scent 12a. When the sheet of material is constructed of a plurality of layers of material, each layer of material may be connected to an adjacent layer of material via a bonding material.

It is to be understood that the decorative preformed pot cover 122 is illustrated as having been formed from a sheet of material 10a provided with a printed pattern 36, however, the sheet of material 10a could be provided with a color in lieu of the printed pattern 36, or the sheet of material 10a may be provided with a color in addition to the printed pattern 36, or the sheet of material 10a maybe be provided with neither the printed pattern 36 or a color.

The decorative preformed pot cover 122 has a base 123 with an upper end 124, a lower end 126, and an outer peripheral surface 128. The pot cover 122 also has a skirt 129 which is connected to the upper end 124 of the base 123 so as to extend outwardly from the upper end 124 of the base 123 of pot cover 122, and the skirt 129 terminates with an outer periphery 131. An opening 130 intersects the upper end 124 of the base 123 of pot cover 122, forming an inner peripheral surface 132 which defines and encompasses a retaining space 133 within which the flower pot 111 containing the floral grouping or plant 134 may be disposed in a manner well known in the art, and which is shown in FIG. 18.

Referring now to FIG. 19, the decorative preformed flower pot cover 122 may be formed using a conventional mold system 140 comprising a male mold 142 and a female mold 144 having a mold cavity 146 for matingly receiving the male mold 142. The sheet of material 10a having the printed pattern 36a and the scent 12a disposed thereon is positioned between the male and female molds 142 and 144, respectively. Movement of the male mold 142 in a direction 148 and into the mold cavity 146 of the female mold 144 forces the sheet of material 10a to be disposed about the portion of the male mold 142 disposed in the mold cavity 146 of the female mold 144 and thereby forms the sheet of material 10a into the preformed decorative flower pot cover 122 (FIG. 17).

Methods for forming preformed decorative pot covers 122 are well known in the art. Two methods of forming such covers are described in U.S. Pat. No. 4,773,182 issued to Weder et al. on Sep. 27, 1988 and U.S. Pat. No. 5,291,721 issued to Weder et al. on Mar. 8, 1994, each of which is expressly incorporated herein by reference. It will be noted that in one preferred embodiment, overlapping folds 149 (see FIGS. 17 and 18) in the pot cover 122 during formation of pot cover 122, and a portion of the overlapping folds 149 can be connected, such as by an application of a bonding material to the sheet of material 10 before forming the sheet of material 10 into pot cover 122 by way of the conventional mold system 140.

Changes may be made in the construction and the operation of the various components, elements and assemblies described herein or in the steps or the sequence of steps of the methods described herein without departing from the spirit and scope of the invention as defined in the following claims.

What is claimed:

1. A method for providing a scented decorative cover about a floral grouping, comprising:
providing a sheet of material having a printed pattern disposed on at least a portion of one surface thereof and a scent on at least a portion of one surface thereof;
providing a floral grouping having a bloom portion and a stem portion; and
wrapping the sheet of material having the printed pattern and the scent thereon about the floral grouping to provide the scented decorative cover for the floral grouping.

2. The method of claim 1 wherein, in the step of providing the sheet of material, the scent is indicative of the printed pattern.

3. The method of claim 2 wherein, in the step of providing the sheet of material, the sheet of material is further defined as having a thickness of from about 0.1 mil to about 30 mils.

4. The method of claim 2 wherein, in the step of providing the sheet of material, the sheet of material is further defined as constructed from a material selected from the group consisting of paper, metal foil, polymeric film, cloth, burlap, laminates and combinations thereof.

5. The method of claim 2 wherein, in the step of providing the sheet of material, the sheet of material is further characterized as having a bonding material disposed on at least a portion of one surface thereof such that when the sheet of material is wrapped about the floral grouping, the bonding material secures the sheet of material in a wrapped condition about the floral grouping, thereby providing the scented decorative cover.

6. The method of claim 1 wherein, in the step of wrapping the sheet of material about the floral grouping to provide the scented decorative cover, the scented decorative cover is conically shaped and provided with an open upper end and an open lower end wherein the bloom portion of the floral grouping is exposed substantially adjacent the open upper end of the scented decorative cover and the stem portion of the floral grouping is exposed substantially adjacent the open lower end of the scented decorative cover.

7. A method for providing a scented decorative cover for a flower pot, comprising:
providing a flower pot having an outer peripheral surface, a lower end and an open upper end;
providing a sheet of material having a scent on at least a portion of one surface thereof and a printed pattern disposed on at least a portion of one surface thereof;
wrapping the sheet of material having the pattern printed thereon about the outer peripheral surface of the flower pot such that the open upper end of the flower pot remains substantially uncovered to provide a scented decorative cover for the flower pot.

8. The method of claim 7 wherein in the step of providing the sheet of material, the scent is indicative of the printed pattern.

9. A method for providing a scented decorative cover for a floral grouping, comprising:
providing a floral grouping having a bloom portion and a stem portion;
providing a sleeve having a scent on at least a portion thereof and a printed pattern on at least a portion of one surface thereof; and
disposing the floral grouping in the sleeve having the scent and the printed pattern thereon, whereby the sleeve substantially surrounds and encompasses the floral grouping and cinching the sleeve about the floral grouping thereby forming the scented decorative cover.

10. The method of claim 9 wherein in the step of providing the sleeve, the scent is indicative of the printed pattern.

11. The method of claim 10 wherein, in the step of providing the sleeve, the sleeve is a flexible sleeve having a bonding material disposed on at least a portion of one surface thereof, and wherein the method further comprises cinching the sleeve disposed about the stem portion of the floral grouping whereby at least a portion of the bonding material on the sleeve is disposed substantially adjacent at least one other portion of the bonding material for securing the flexible sleeve about the floral grouping.

12. The method of claim 10 wherein, in the step of providing the sleeve, the sleeve is further defined as having a first end, a second end, and an outer periphery which forms an outer surface on which the printed pattern is disposed, the sleeve having an opening which intersects both the first and second ends forming an inner surface defined by an inner periphery which forms a retaining space for receiving the floral grouping.

13. The method of claim 10 wherein, in the step of providing the sleeve having the scent and the printed pattern indicative of the scent thereon, the sleeve is constructed from a material selected from the group consisting of paper, metal foil, polymeric film, non-polymeric film, cloth, burlap, laminates and combinations thereof.

14. The method of claim 10 wherein, in the step of providing the sleeve having a scent and a printed pattern indicative of the scent thereon, the sleeve is further characterized as having a thickness of from about 0.1 mil to about 30 mils.

15. A method for providing a decorative cover for a flower pot having a floral grouping disposed therein, comprising:
providing a flower pot having floral grouping disposed therein;
providing a sleeve having a scent and a printed pattern thereon; and
disposing the flower pot in the sleeve having the scent and the printed pattern whereby the sleeve substantially surrounds and encompasses the flower pot with the floral grouping disposed therein.

16. The method of claim 15 wherein in the step of providing the sleeve, the scent is indicative of the printed pattern.

17. The method of claim 16 wherein, in the step of providing a sleeve, the sleeve has a bonding material disposed thereon on the sleeve for securing the sleeve about the flower pot.

18. The method of claim 16 wherein, in the step of providing the sleeve, the sleeve is constructed from a material selected from the group consisting of paper, metal foil, polymeric film, non-polymeric film, cloth, burlap, laminates and combinations thereof.

19. A method for forming a decorative cover about a flower pot, comprising:
providing a flower pot having an outer peripheral surface, a lower end and an open upper end, the flower pot defining a floral containing space formed therein;
providing a sheet of material having a scent and a printed pattern indicative of the scent thereon;
forming the sheet of material into a preformed pot cover having the scent and the printed pattern, the preformed pot cover comprising a preformed base and a skirt, the preformed base being sized to contain the flower pot and having an upper end, a lower end, an outer peripheral surface and a pot opening formed through the upper end thereof providing access to a pot receiving space, the skirt connected to the upper end of the preformed base so as to extend an distance outwardly from the upper end of the base and terminating with an outer periphery; and
positioning the flower pot in the pot receiving space of the preformed pot cover such that the open upper end of the flower pot remains substantially uncovered and thereby provide the decorative cover about the flower pot.

20. A method for forming a decorative cover about a flower pot, comprising:
providing a flower pot having an outer peripheral surface, a lower end and an open upper end, the flower pot defining a floral containing space formed therein;
providing a sheet of material having a scent and a printed pattern indicative of the scent on at least a portion thereof;
forming the sheet of material into a preformed pot cover comprising a preformed base and a skirt, the preformed base being sized to contain the flower pot and having an upper end, a lower end, an outer peripheral surface and a pot opening formed through the upper end thereof providing access to a pot receiving space, the skirt connected to the upper end of the preformed base so as to extend an distance outwardly from the upper end of the base and terminating with an outer periphery; and
positioning the flower pot in the pot receiving space of the preformed pot cover such that the open upper end of the flower pot remains substantially uncovered and thereby provide the decorative cover about the flower pot.

21. The method for forming a decorative cover about a flower pot of claim 20 wherein, in the step of providing at least one sheet of material having a scent and a printed pattern indicative of the scent, the sheet of material is further defined as having a thickness of from about 0.1 mil to about 30 mils.

22. The method for forming a decorative cover about a flower pot of claim 20 wherein, in the step of providing at least one sheet of material having a scent and a printed pattern indicative of the scent, the sheet of material is further defined as constructed from a material selected from the group consisting of paper, metal foil, polymeric film, non-polymeric film, cloth, burlap, laminates and combinations thereof.

23. The method for forming a decorative cover about a flower pot of claim 20 wherein, in the step of providing at least one sheet of material having a scent and a printed pattern indicative of the scent, the sheet of material is further defined as having an extension portion connected to the outer periphery of the skirt which is selectively detachable from the skirt.
